(19) United States
(12) Patent Application Publication
(10) Pub. No.: US 2019/0368361 A1
(43) Pub. Date: Dec. 5, 2019

(54) NON-SYMMETRIC FAN BLADE TIP CLADDING

(71) Applicant: General Electric Company, Schenectady, NY (US)

(72) Inventors: Nicholas Joseph Kray, Mason, OH (US); Douglas Duane Ward, West Chester, OH (US); Gregory Carl Gemeinhardt, Park Hills, KY (US); David William Crall, Loveland, OH (US); Wendy Wen-Ling Lin, Montgomery, OH (US)

(21) Appl. No.: 15/997,872

(22) Filed: Jun. 5, 2018

(51) Int. Cl. F01D 5/28; F01D 5/14

(52) U.S. Cl. CPC F01D 5/288; F01D 5/282; F01D 5/147; F05D 2250/73; F05D 2230/90; F05D 2240/307; F05D 2220/36

(57) ABSTRACT

Fan blade includes airfoil with leading and trailing edges, pressure and suction sides extending outwardly from airfoil base to airfoil tip, and tip cladding with non-symmetric pressure and suction side cladding flanks bonded to airfoil tip along pressure and suction sides respectively. Pressure and suction side cladding flanks may include non-symmetric or different pressure and suction side cladding radial heights and/or different pressure and suction side cladding radial locations of pressure and suction side cladding flank portions of pressure and suction side cladding flanks in tip cladding portion of tip cladding. One cladding radial heights may be variable in tip cladding portion. Chordwise extending seam may be in pressure side cladding flank portion and/or chordwise extending slot may be in suction side cladding flank portion. Cladding flanks may be stronger, more ductile, or less brittle than composite material of composite core of airfoil.

### BACKGROUND OF THE INVENTION

### Field of the Invention

The invention relates to gas turbine engine blades with tip cladding and, particularly, to composite fan blades with tip metallic cladding.

### Description of Related Art

Aircraft gas turbine engines typically include a fan assembly with a row of fan blades surrounded by a fan casing. Such blades may be subject to events that cause at least partial fan blade breakage. Such breakage facilitates primary damage which includes the affected blade and the immediately downstream blades as they contact the material released from the affected blade. Such primary damage may induce rotor unbalancing conditions and subsequent blade rubs against the fan casing. The blade rubs may facilitate secondary damage that includes damage to non-adjacent blades and the casing.

Many known fan assemblies are designed with a sufficient margin of error and constructed with sufficient additional load-carrying capabilities to compensate for such unbalanced rotor conditions and reduce a potential for damage in blade breakage events. Such additional load-carrying capabilities increase cost of construction of the fan assemblies and decrease a gas turbine engine fuel efficiency due to the increased weight of the fan assemblies.

At least one proposed blade assembly includes a blade tip fuse within at least a tip portion of the fan blade. The blade includes a composite airfoil with a metal leading edge coupled to at least a portion of the airfoil and the MLE includes at least one blade tip fuse. It is desirable to provide a less costly, simpler, and lower weight design blade tip fuse design.

### BRIEF DESCRIPTION OF THE INVENTION

A gas turbine engine fan blade includes an airfoil including chordwise spaced apart leading and trailing edges, pressure and suction sides extending outwardly in a spanwise direction from an airfoil base to an airfoil tip, and tip cladding including non-symmetric pressure and suction side cladding flanks bonded or otherwise attached to the airfoil tip along the pressure and suction sides respectively.

The pressure and suction side cladding flanks may include non-symmetric or different pressure and suction side cladding radial heights and/or different pressure and suction side cladding radial locations of pressure and suction side cladding flank portions of the pressure and suction side cladding flanks in a tip cladding portion of the tip cladding. One of the different pressure and suction side cladding radial heights may be variable in the tip cladding portion.

The blade may include pressure and suction side cladding flank portions of the pressure and suction side cladding flanks in a tip cladding portion of the tip cladding, a chordwise extending seam in the pressure side cladding flank portion, and/or a chordwise extending relief or slot in the suction side cladding flank portion.

The blade may include the pressure and suction side cladding flanks bended or otherwise attached to a composite core of the airfoil and the pressure and suction side cladding flanks being stronger, more ductile, or less brittle than a composite material of the composite core.

An aircraft turbofan gas turbine engine may include at least one row of aircraft gas turbine engine fan blades positioned within an engine casing, one or more of the fan blades may include an airfoil with chordwise spaced apart leading and trailing edges, pressure and suction sides extending outwardly in a spanwise direction from an airfoil base to an airfoil tip, and tip cladding including non-symmetric pressure and suction side cladding flanks bonded or otherwise attached to the airfoil tip along the pressure and suction sides respectively.

### BRIEF DESCRIPTION OF THE DRAWINGS

The foregoing aspects and other features of the invention are explained in the following description, taken in connection with the accompanying drawings where:

FIG. 1 is a schematic view illustration of an exemplary gas turbine engine.

FIG. 2 is a schematic side view illustration of an exemplary fan blade assembly that may be used with the gas turbine engine illustrated in FIG. 1.

FIG. 3 is a schematic view illustration of an exemplary asymmetric tip cladding taken through 3-3 of the fan blade assembly illustrated in FIG. 2.

FIG. 4 is a schematic view illustration of a second exemplary asymmetric tip cladding taken through 4-4 of the fan blade assembly illustrated in FIG. 2.

FIG. 5 is a schematic side view illustration of a third exemplary asymmetric tip cladding embodiment that may be used with the fan blade assembly gas turbine engine illustrated in FIG. 2.

FIG. 6 is a schematic side view illustration of a fourth exemplary asymmetric tip cladding embodiment that may be used with the fan blade assembly gas turbine engine illustrated in FIG. 2.

FIG. 7 is a schematic view illustration of the exemplary asymmetric tip cladding taken through 7-7 of the fan blade assembly illustrated in FIG. 5.

### DETAILED DESCRIPTION OF THE INVENTION

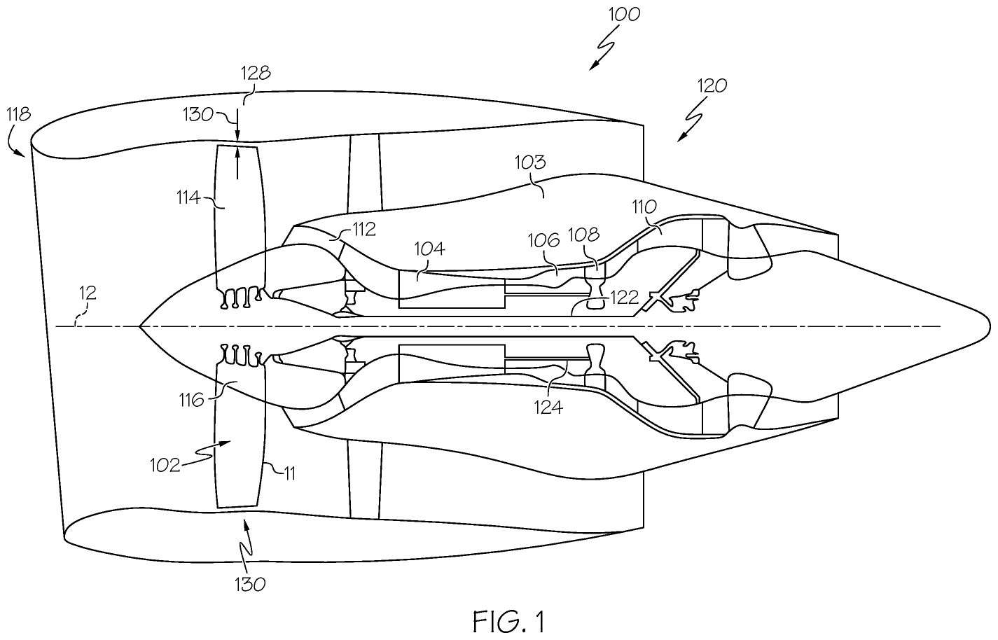

Illustrated in FIG. 1 is an exemplary aircraft turbofan gas turbine engine 100 including a fan 102 and a core engine 103 with a high pressure compressor 104 and a combustor 106, all circumscribed about an engine centerline 12. Engine 100 also includes a high pressure turbine 108, a low pressure turbine 110, and a booster 112. Fan 102 includes at least one row of fan blades 11 extending radially outward from a rotor disk 116. Engine 100 has an inlet 118 and an outlet 120. Fan 102 and turbine 110 arc coupled together using a first rotor shaft 122, and compressor 104 and turbine 108 are coupled together using a second rotor shaft 124. The fan blades 11 are at least partially positioned within an engine casing 128 and the engine suitably designed to be mounted to a wing or fuselage of an aircraft. A clearance 130 is maintained between the fan blades 11 and the engine casing 128.

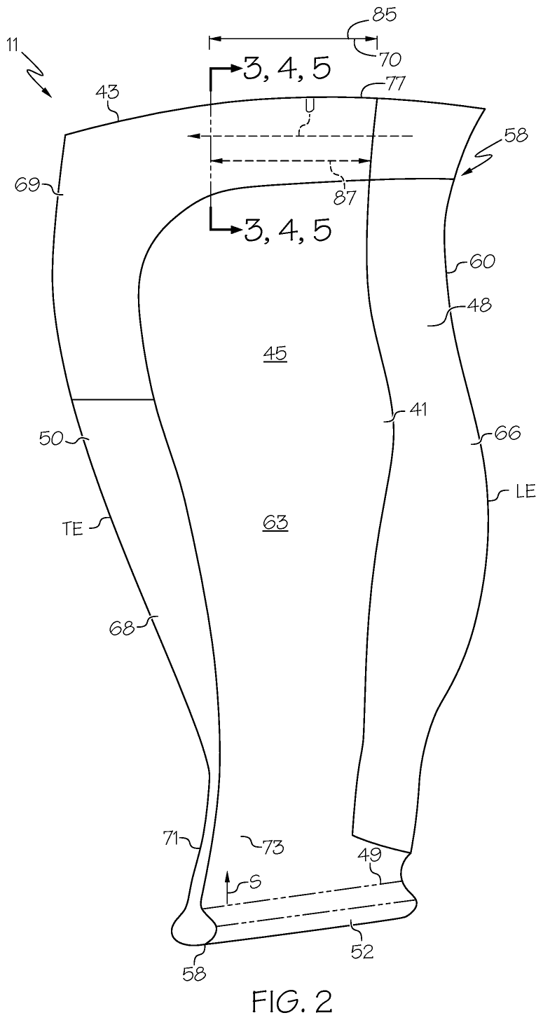

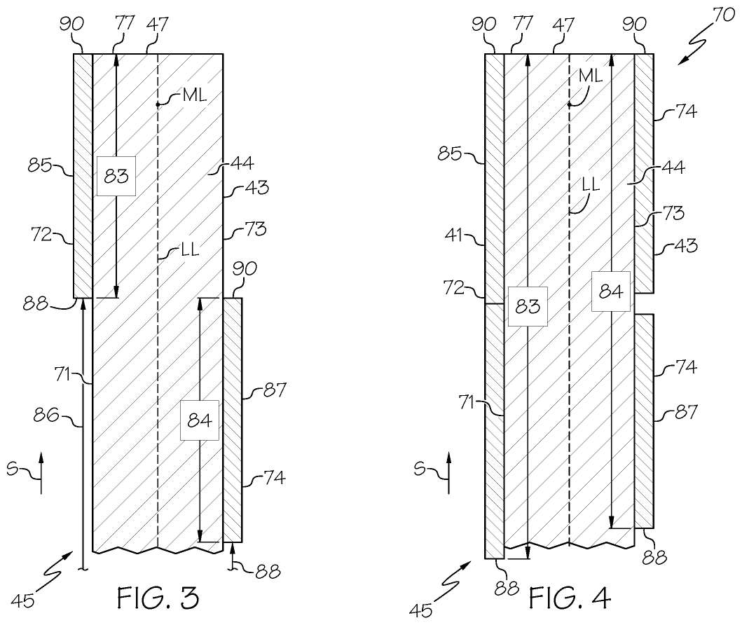

Illustrated in FIG. 2 is one embodiment of the fan blade 11 that may be used in engine 103 (illustrated in FIG. 1). The fan blade 11 includes an airfoil 45 extending outwardly from a root 52 in a spanwise S direction. Alternatively, airfoil 45 may be used with, but not limited to, rotor blades, stator vanes, and/or nozzle assemblies. Airfoil 45 may also be used with, OCVs and the booster. In the exemplary embodiment, the root 52 includes an integral dovetail 58 that enables the fan blade 11 to be mounted to the rotor disk 116. The airfoil 45 includes pressure and suction sides 41, 43 extending outwardly in a spanwise direction along a span S from an airfoil base 49 to an airfoil tip 47. The exemplary pressure and suction sides 41, 43 illustrated herein are concave and convex respectively. The airfoil 45 extends along a chord C between chordwise spaced apart leading and trailing edges LE, TE. The chord C of the airfoil 45 is a line between the leading LE and trailing edge TE at each cross-section of the airfoil. The pressure side 41 of the airfoil 45 faces in the general direction of rotation and the suction side 43 is on the other side of the airfoil and a mean-line ML is generally disposed midway between the two faces in the chordwise direction as further illustrated in FIGS. 3 and 4,

The airfoil 45 may be mounted on and integral with a hub instead of the platform and disk to form an integrally bladed rotor (IBR). Alternatively, fan blade 11 may have any conventional form with or without dovetail 58. For example, fan blade 11 may be formed integrally with disk 116 in a blisk-type configuration that does not include the dovetail 58.

Referring to FIGS. 2-4, the airfoil 45 includes a composite core 44 made of a composite material, generally airfoil shaped, and includes a central core portion 63 extending chordwise downstream from a leading edge portion 48 to a trailing edge portion 50 of the composite core 44. The composite core 44 includes pressure and suction side surfaces 71, 73 extending outwardly in a spanwise direction along a span S from the airfoil base 49 to a core tip 77. Leading and trailing edge claddings 66, 68 cover the leading and trailing edge portions 48, 50 respectively and tip cladding 69 covers the core tip 77. The claddings are made of a metallic or other suitable material and which then define the leading and trailing edges LE, TE and tip of the airfoil and are far more capable of bearing strain than the composite core 44. The leading and trailing edge claddings 66, 68 and the tip cladding 69 may be bonded to the composite core 44.

The tip cladding 69 is non-symmetric and includes a non-symmetric tip cladding portion 70 extending chordwise as illustrated by dashed line and arrow U in FIG. 2. The non-symmetric tip cladding portion 70 may include non-symmetric pressure and suction side flanks 72, 74 that are bonded or otherwise attached to pressure and suction side surfaces 76, 78 respectively of the core tip 77 as illustrated in FIGS. 3 and 4. The bonding may use a film adhesive for example. The tip cladding 69 may be made of any suitable material that is stronger or more ductile or less brittle than the composite material of the composite core 44. The non-symmetric pressure and suction side flanks 72, 74 may be non-symmetric about the mean-line ML. A dashed line indicates a locus LL of the mean-lines ML in FIGS. 3 and 4. The tip cladding portion 70 may include pressure and suction side cladding flank portions 85, 87 of the pressure and suction side cladding flanks 72, 14 respectively. The pressure and suction side cladding flanks 72, 74 may further include pressure and suction side non-symmetric portions 80, 82.

FIG. 3 illustrates first exemplary embodiments of the non-symmetric pressure and suction side flanks 72, 74 having non-symmetric or different pressure and suction side cladding radial heights 83, 84 and/or pressure and suction side cladding radial locations 96, 98 of the pressure and suction side cladding flank portions 85, 87 of the pressure and suction side cladding flanks 72, 74 in the tip cladding portion 70. The pressure and suction side cladding radial heights 83, 84 may be measured spanwise S between inner and outer boundaries 89, 90 of the pressure and suction side cladding flank portions 95, 87. The pressure and suction side cladding radial locations 86, 88 may be measured spanwise S from the airfoil base to the pressure and suction side cladding flank portions 85, 87.

FIG. 4 illustrates other exemplary embodiments of the non-symmetric pressure and suction side flanks 72, 74. The non-symmetric pressure and suction side flanks 72, 74 have about the same pressure and suction side cladding radial heights 83, 84. The pressure side cladding flank portion 85 includes a chordwise extending seam 94 and the suction side cladding flank portion 87 includes a chordwise extending relief or slot 98 in the tip cladding portion 70. The tip cladding portion 70 may include one or both the seam 94 and the relief or slot 98.

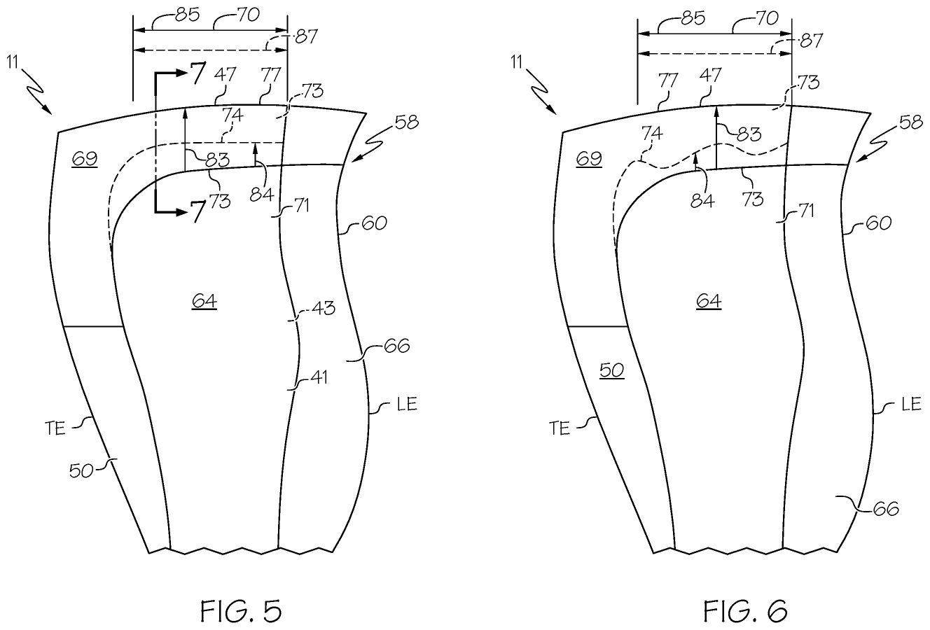

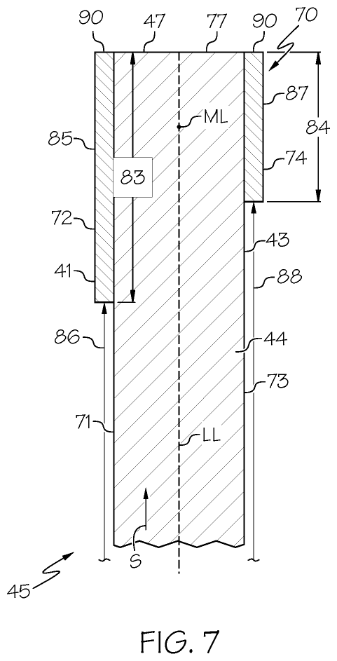

FIGS. 5 and 7 illustrate another exemplary embodiment of the non-symmetric pressure and suction side flanks 72, 74 having non-symmetric or different pressure and suction side cladding radial heights 83, 84 extending inwardly from the core tip 77. FIGS. 6 and 7 illustrate another exemplary embodiment of the non-symmetric pressure and suction side flanks 72, 74 having non-symmetric or different pressure and suction side cladding radial heights 83, 84 and a variable suction side cladding radial height 84 extending inwardly from the core tip 77. Alternatively, the pressure side cladding radial height S3 may be variable of both the pressure and suction side cladding radial heights 83, 84 may be variable.

The non-symmetric tip cladding 69 selectively locates cladding to tailor stiffness and allow for blade frangibility. Selectively locating the cladding on the pressure and suction sides may create a fuse that will allow the blade or airfoil to fail during extreme rub events between the fan blades 11 and engine casing 128. This may allow the use for a lower weight and lower cost fan blade containment system in a portion of the engine casing 128 surrounding the fan blades 11.

The present invention has been described in an illustrative manner. It is to be understood that the terminology which has been used is intended to be in the nature of words of description rather than of limitation. While there have been described herein, what are considered to be preferred and exemplary embodiments of the present invention, other modifications of the invention shall be apparent to those skilled in the art from the teachings herein and, it is, therefore, desired to be secured in the appended claims all such modifications as fall within the true spirit and scope of the invention.

Accordingly, what is desired to be secured by Letters Patent of the United States is the invention as defined and differentiated in the following claims:

What is claimed:

1. A gas turbine: engine fan blade comprising:
an airfoil including chordwise spaced apart leading and trailing edges,
the airfoil further including pressure and suction sides extending outwardly in a spanwise direction from an airfoil base to an airfoil tip, and
tip cladding including non-symmetric pressure and suction side cladding flanks bended or otherwise attached to the airfoil tip along the pressure: and suction sides respectively.

2. The blade as claimed in claim 1, further comprising pressure and suction side non-symmetric portions of the pressure and suction side cladding flanks.

3. The blade as claimed in claim 1, further comprising the pressure and suction side cladding flanks including non-symmetric or different pressure and suction side cladding radial heights and/or different pressure and suction side cladding radial locations of pressure and suction side cladding flank portions of the pressure and suction side cladding flanks in a tip cladding portion of the tip cladding.

4. The blade as claimed in claim 3, further comprising one of the different pressure and suction side cladding radial heights being variable in the tip cladding portion.

5. The blade as claimed in claim 1, further comprising: pressure and suction side cladding flank portions of the pressure and suction side cladding flanks in a tip cladding portion of the tip cladding,
a chordwise extending seam in the pressure side cladding flank portion, and/or
a chordwise extending relief or slot in the suction side cladding flank portion.

6. The blade as claimed in claim 1, further comprising the pressure and suction side cladding flanks bonded or otherwise attached to a composite core of the airfoil and the pressure and suction side cladding flanks being stronger, more ductile, or less brittle than a composite material of the composite core.

7. The blade as claimed in claim 6, further comprising the pressure and suction side cladding flanks including non-symmetric or different pressure and suction side cladding radial heights and/or different pressure and suction side cladding radial locations of pressure and suction side cladding flank portions of the pressure and suction side cladding flanks in a tip cladding portion of the tip cladding.

8. The blade as claimed in claim 7, further comprising one of the different pressure and suction side cladding radial heights being variable in the tip cladding portion.

9. The blade as claimed in claim 6, further comprising: pressure arid suction side cladding flank portions of the pressure and suction side cladding flanks in a tip cladding portion of the tip cladding,
a chordwise extending seam in the pressure side cladding flank portion, and/or
a chordwise extending relief or slot in the suction side cladding flank portion.

10. An aircraft turbofan gas turbine engine comprising:
at least one row of aircraft gas turbine engine fan blades positioned within an engine casing,
one or more of the fan blades including an airfoil,
the airfoil including chordwise spaced apart leading and trailing edges and pressure and suction sides extending outwardly in a spanwise direction from an airfoil base to an airfoil tip, and
tip cladding including non-symmetric pressure and suction side cladding flanks bonded or otherwise attached to the airfoil tip along the pressure and suction sides respectively.

11. The engine as claimed in claim 10, further comprising pressure and suction side non-symmetric portions of the pressure and suction side cladding flanks.

12. The engine as claimed in claim 10, further comprising the pressure and suction side cladding flanks including non-symmetric or different pressure and suction side cladding radial heights and/or different pressure and suction side cladding radial locations of pressure and suction side cladding flank portions of the pressure and suction side cladding flanks in a tip cladding portion of the tip cladding.

13. The engine as claimed in claim 12, further comprising one of the different pressure and suction side cladding radial heights being variable in the tip cladding portion.

14. The engine as claimed in claim 10, further comprising:
pressure and suction side cladding flank portions of the pressure and suction side cladding flanks in a tip cladding portion of the tip cladding,
a chordwise extending seam in the pressure side cladding flank portion, and/or
a chordwise extending relief or slot in the suction side cladding flank portion.

15. The engine as claimed in claim 10, further comprising the pressure and suction side cladding flanks bonded or otherwise attached to a composite core of the airfoil and the pressure and suction side cladding flanks being stronger, more ductile, or less brittle than a composite material of the composite core.

16. The engine as claimed in claim 15, further comprising the pressure and suction side cladding flanks including non-symmetric or different pressure and suction side cladding radial heights and/or different pressure and suction side cladding radial locations of pressure and suction side cladding flank portions of the pressure and suction side cladding flanks in a tip cladding portion of the tip cladding.

17. The engine as claimed in claim 16, further comprising one of the different pressure and suction side cladding radial heights being variable in the tip cladding portion.

18. The engine as claimed in claim 17, further comprising:
pressure and suction side cladding flank portions of the pressure and suction side cladding flanks in a tip cladding portion of the tip cladding,
a chordwise extending seam in the pressure side cladding flank portion, and/or
a chordwise extending relief or slot in the suction side cladding flank portion.

19. The engine as claimed in claim 15, further comprising leading and trailing edge claddings covering leading and trailing edge portions respectively of the composite core.

20. The engine as claimed in claim 19, further comprising leading and trailing edge claddings and the tip cladding being metallic.
